(19) United States
(12) Patent Application Publication
(10) Pub. No.: US 2014/0022957 A1
(43) Pub. Date: Jan. 23, 2014

(54) TELEPHONE COMMUNICATION METHOD

(71) Applicants: Nen-Fu HUANG, Hsinchu (TW); Wei-Kuan Shih, Hsinchu (TW)

(72) Inventors: Nen-Fu HUANG, Hsinchu (TW); Wei-Kuan Shih, Hsinchu (TW)

(21) Appl. No.: 13/845,464

(22) Filed: Mar. 18, 2013

(30) Foreign Application Priority Data
Jul. 20, 2012 (TW) 101126401

(51) Int. Cl. H04L 29/06

(52) U.S. Cl. CPC H04L 65/403
USPC 370/261; 370/259

(57) ABSTRACT

The present invention discloses a telephone communication method and a system thereof. The method comprises following steps: sending a communication request signal via a first dialer; receiving the communication request signal by a server for sending a communication connection signal to a first telecommunication device and a second telecommunication device with a predetermined account number corresponding to the server according to the communication request signal, such that a communication connection channel is established between the first telecommunication device and the second telecommunication device by the server; and using the first telecommunication device for executing the voice communication or the video communication with the second telecommunication device.

### CROSS-REFERENCE TO RELATED APPLICATION

This application claims the benefit of Taiwan Patent Application No. 101126401, filed on Jul. 20, 2012, in the Taiwan Intellectual Property Office, the disclosure of which is incorporated herein in its entirety by reference.

### FIELD OF THE INVENTION

The present invention relates to a telephone communication method, and more particularly to the telephone communication method capable of dividing a dialer end and a talker end into two devices, and connecting the talker end with other talker ends via a multiple of servers by an account number matching method, so that the talker end can communicate with other talker ends.

### BACKGROUND OF THE INVENTION

Telephone is a long-distance communication device capable of receiving and transmitting sound, and the birth of telephone brings tremendous convenience to our life and allows people to contact with each other for personal matters or business and promote the exchange of feelings between.

In general, telephones include home phones (or cable phones), public phones and mobile phones (or wireless phones). At present, people can use computers or Smartphones to make calls for conversion via network phones. For example, communication software such as Skype and Msn is provided for communication via Internet phones. As communication technologies continue to advance, we enjoy better communication quality and service.

However, the dialer end and the talker end are still tied to one device so far. When a user performs telephone communications, the user has to dial a number and talk with others by the same device, thus limiting the scope of applicability of the telephone technology.

### SUMMARY OF THE INVENTION

In view of the aforementioned drawbacks of the prior art, it is a primary objective of the present invention to provide a telephone communication method, so that the same user can dial a number or talk with others through different devices to improve the flexibility of the telephone technology.

To achieve the aforementioned objective, the present invention provides a telephone communication method comprising the steps of: sending a communication request signal via a first dialer; receiving the communication request signal by a server for sending a communication connection signal to a first telecommunication device and a second telecommunication device with a predetermined account number corresponding to the server according to the communication request signal to establish a communication connection channel between the first telecommunication device and the second telecommunication device; and using the first telecommunication device and the second telecommunication device to conduct a voice communication or a video communication.

Preferably, the server is a Session Initiation Protocol (SIP) server and the predetermined account number is a SIP account number created by the server,

Preferably, the first dialer and the first telecommunication device are provided for the same user to dial a number or talk with others, and the second telecommunication device is provided for another user to talk with others.

Preferably, the telephone communication method of the present invention further comprises the steps of: designating the first telecommunication device as a talking tool and sending the communication request signal by the first telecommunication device; and sending the communication connection signal to the first telecommunication device and the second telecommunication device corresponding to the predetermined account number of the first telecommunication device according to the communication request signal via the server to establish the communication connection channel between the first telecommunication device and the second telecommunication device.

Preferably, the telephone communication method of the present invention further comprises the steps of: using the first dialer to provide the user to select another user as a talking object, and sending the communication request signal by the first dialer; receiving the communication request signal by a cloud interface, and using the predetermined account number of the designated first telecommunication device as a search element to search the predetermined account number registered by the another user corresponding to the predetermined account number of the first telecommunication device; sending the communication request signal to the server corresponding to the predetermined account number by the cloud interface; and sending the communication connection signal to the first telecommunication device and the second telecommunication device of the predetermined account number registered by the another user according to the communication request signal by the server.

Preferably, the first telecommunication device, the second telecommunication device and the server come with a plural quantity each, and each of the first telecommunication devices and each of the second telecommunication devices corresponding to one of the predetermined account numbers are registered and saved in the cloud interface, and each of the predetermined account numbers corresponds to one of the servers, and the telephone communication method comprises the steps of: designating at least one of the first telecommunication devices as a talking tool and sending the communication request signal by the first dialer; using the predetermined account number of the first telecommunication device designated as the talking tool via the cloud interface as a search element to search the second telecommunication device matched with the predetermined account number of one of the first telecommunication devices; and sending the communication request signal to one of the servers corresponding to the predetermined account number according to the matched predetermined account number via the cloud interface, and then sending the communication connection signal by the corresponding server to the first telecommunication device and second telecommunication device are matched.

Preferably, the telephone communication method of the present invention is applicable for being executed under a Voice over Internet Protocol (VOW).

Preferably, the telephone communication method of the present invention further comprises the steps of: sending the communication connection signal to the first telecommunication device, the second telecommunication device and other telecommunication devices with the predetermined account number corresponding to the server according to the communication request signal by the server; and establishing the communication connection channel between the first telecommunication device, the second telecommunication device and the other telecommunication devices by the server, and conducting a multi-party voice or video conference by the first telecommunication device, the second telecommunication device and the other telecommunication devices.

In summation, the telephone communication method of the present invention has one or more of the following advantages:

(1) The telephone communication method are provided for the same user to dial a number and talk with others by using different devices without being limited to the same device for dialing and talking anymore, and thus providing more flexible applications. For, example, the user dials a number from a mobile phone, and talks to others by a television, and users can dial a number and talk with others according to their preference.

(2) The telephone communication method can search a group or a telecommunication company jointly used by the calling party and the receiving party via the overall operation architecture of the cloud interface and the multiple of servers, and then connect the talking ends of the calling and receiving parties with the corresponding account number, so that the calling and receiving parties can have better calling service and quality. For example, a user has a plurality of talkers, and another user also has a plurality of talkers, and each talker of the two users has a SIP account number corresponding to a SIP server. When the user dial a number from another device (which is the dialer), the cloud interface can find the talker with the corresponding SIP account number between the two users, and the server with the corresponding SIP account number transmits the communication service to the two talkers to allow the user to talk with the other user. Therefore, the two users can have calling services with a lower rate or more other calling services, and the invention can improve the overall communication quality effectively.

### BRIEF DESCRIPTION OF THE DRAWINGS

FIG. 1 is a flow chart of a telephone communication method of the present invention;

FIG. 2 is a first schematic view of a telephone communication method of a preferred embodiment of the present invention;

FIG. 3 is a second schematic view of a telephone communication method of a preferred embodiment of the present invention; and

FIG. 4 is a third schematic view of a telephone communication method of a preferred embodiment of the present invention.

### DESCRIPTION OF THE PREFERRED EMBODIMENTS

The technical characteristics, contents, advantages and effects of the present invention will be apparent with the detailed description of a preferred embodiment accompanied with related drawings as follows. The drawings are provided for the illustration, and same numerals are used to represent respective elements in the preferred embodiments. It is intended that the embodiments and drawings disclosed herein are to be considered illustrative rather than restrictive. Same numerals are used for representing same respective elements in the drawings.

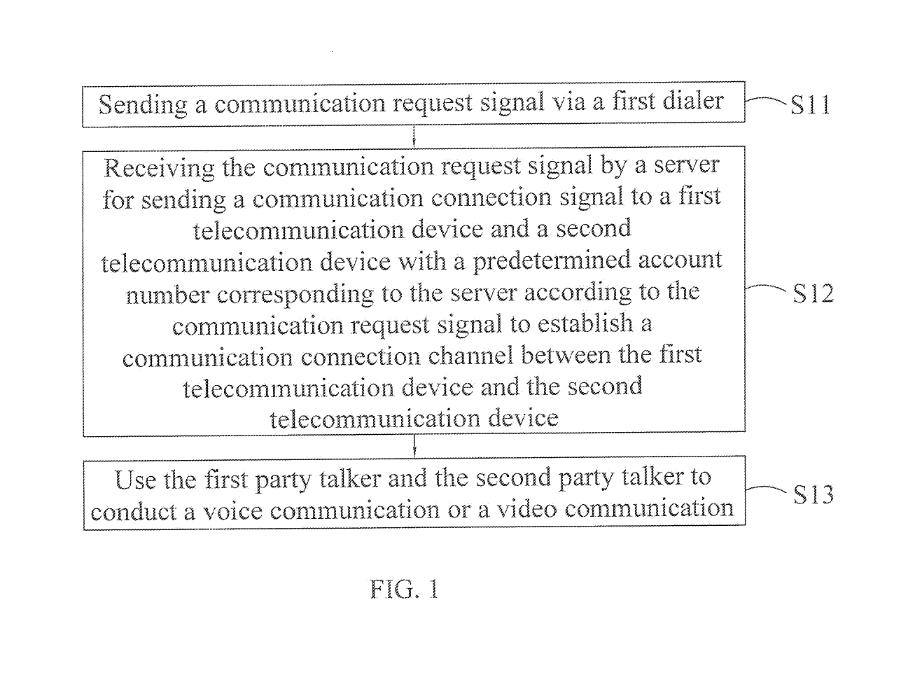

With reference to FIG. 1 for the flow chart of a telephone communication method of the present invention, the method comprises the following steps:

S11 Send a communication request signal via a first dialer.

S12 Receive the communication request signal by a server for sending a communication connection signal to a first telecommunication device and a second telecommunication device with a predetermined account number corresponding to the server according to the communication request signal to establish a communication connection channel between the first telecommunication device and the second telecommunication device.

S13 Use the first telecommunication device and the second telecommunication device to conduct a voice communication or a video communication.

The main purpose of the present invention is to operate the dialer and the talker separately instead of being limited to the use of the same device. In other words, a user can use different devices for dialing a number and talking respectively. When the user dials a call from a dialer, the server sends a service request to a talker which is the talker used by the same user and a talker used by the receiving party, so that the two can talk with each other.

The telephone communication method is applicable for the execution under Voice over Internet Protocol (VOIP), and the server used can be a SIP server, and the predetermined account number is a SIP account number created by the server. However, the invention is not limited by the aforementioned arrangements. The first dialer and the first telecommunication device are provided for the same user to dial a number and talk with others respectively, and the second telecommunication device is provided for another user to talk with others. Wherein, the first dialer, the first telecommunication device and the second telecommunication device can be any device with a telephone communication function including but not limited to a computer, a mobile phone, a personal digital assistant or a television.

The telephone communication method of the present invention further comprises the steps of: designating the first telecommunication device as a talking tool and sending the communication request signal by the first telecommunication device; and sending the communication connection signal to the first telecommunication device and the second telecommunication device corresponding to the predetermined account number of the first telecommunication device according to the communication request signal via the server to establish the communication connection channel between the first telecommunication device and the second telecommunication device. More specifically, the telephone communication method of the present invention further comprises the steps of: using the first dialer to provide the user to select another user as a talking object, and sending the communication request signal by the first dialer; receiving the communication request signal by a cloud interface, and using the predetermined account number of the designated first telecommunication device as a search element to search the predetermined account number registered by the another user corresponding to the predetermined account number of the first telecommunication device; sending the communication request signal to the server corresponding to the predetermined account number by the cloud interface; and sending the communication connection signal to the first telecommunication device and the second telecommunication device of the predetermined account number registered by another user according to the communication request signal by the server.

Since each person usually has more than one device used for communications now, therefore it is preferable to have a plurality of first dialers, a plurality of first telecommunication devices, a plurality of second telecommunication devices and a plurality of servers to constitute the overall communication architecture for a multiple of dialing, calling and servo services. Wherein, each of the first telecommunication devices and second telecommunication devices corresponding to a respective predetermined account number registered and saved in a cloud interface, and each predetermined account number corresponds to a respective server, and this telephone communication method comprises the steps of: designating at least one of the first telecommunication devices as a talking tool and sending the communication request signal by the first dialer; using the predetermined account number of the first telecommunication device designated as the talking tool via the cloud interface as a search element to search the second telecommunication device matched with the predetermined account number of one of the first telecommunication devices; and sending the communication request signal to one of the servers corresponding to the predetermined account number according to the matched predetermined account number via the cloud interface, and then sending the communication connection signal by the corresponding server to the first telecommunication device and second telecommunication device are matched.

Another purpose of the present invention is to provide better communication service and quality to people. Accounts number registered and used by a plurality of users such as the SIP account numbers can be saved in the cloud interface, and these SIP account numbers correspond to one of their respective SIP servers. A SIP server and a SIP account number created by the SIP server and used by the user can be used to set the users in the same group or obtain the same communication service. For example, the service group of a SIP server includes the employees of a company, and the employees of the company have set their account numbers for communication and saved the account numbers by the cloud interface. If one of the employees wants to use his/her own dialer to dial a number to another employee, the cloud interface will find the corresponding account number corresponding to the employee who makes the call and the other employee who will receive the call. In other words, the cloud interface will find out the account number created by the SIP server of the company and will issue an instruction to the corresponding SIP server. Finally, the SIP server connects the talkers of the two employees through the corresponding account number found by the cloud interface, so that the two employees can talk with each other through the two talkers.

In addition, the telephone communication method of the present invention can be used for a three-party conference and the method comprises the steps of: sending a communication connection signal to a first telecommunication device, a second telecommunication device and other telecommunication devices with predetermined account numbers corresponding to the server according to the communication request signal by the server, and establishing a communication connection channel between the first telecommunication device, the second telecommunication device and the other telecommunication devices, so that the first telecommunication device, the second telecommunication device and the other telecommunication devices can conduct a multi-party voice or video conference.

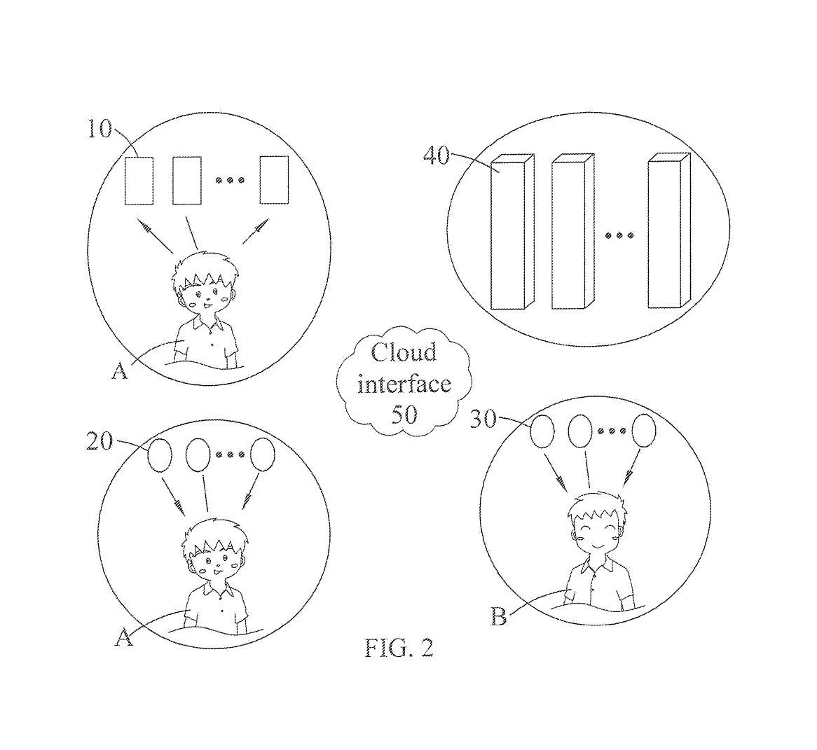

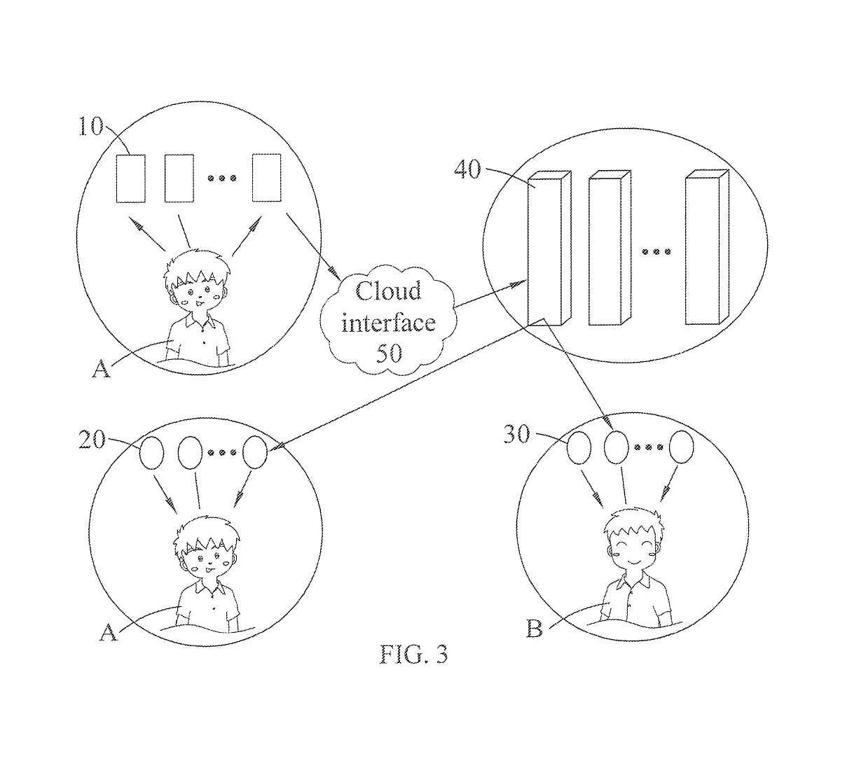

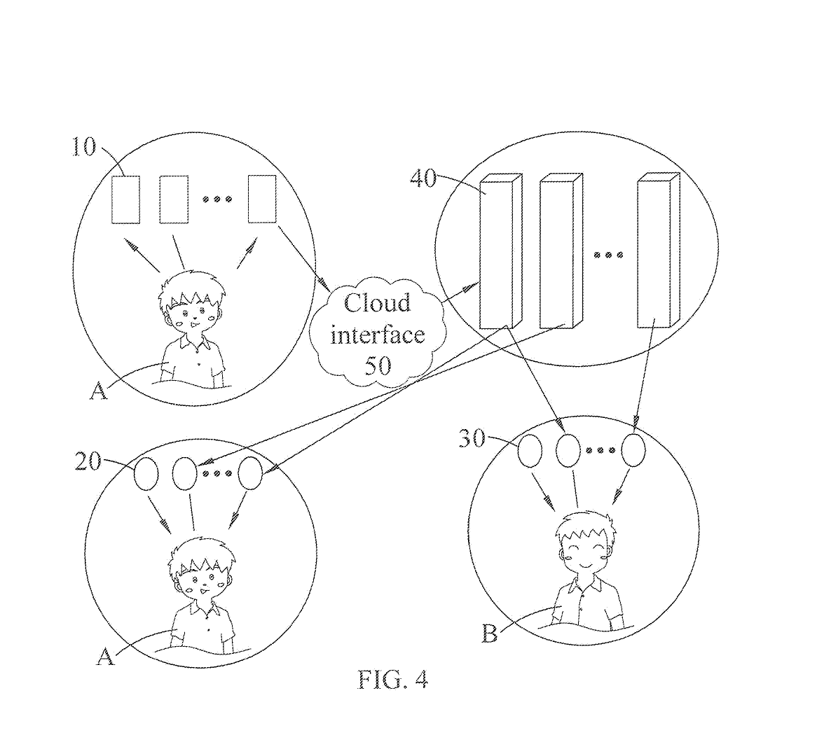

With reference to FIGS. 2 to 4 for the first, second and third schematic views of a telephone communication method in accordance with a preferred embodiment of the present invention respectively, the telephone communication system comprises a plurality of first dialers 10, a plurality of first telecommunication devices 20, a plurality of second telecommunication devices 30, a plurality of servers 40 and a cloud interface 50. The first dialer 10 and the first telecommunication device 20 are owned by the same user A, and the second telecommunication device 30 is owned by a user B as shown in FIG. 2. When the user A wants to talk with the user B, the user A can use one of the first dialer 10 for dialing a number and designate at least one of the first telecommunication devices 20 for talking. The cloud interface 50 receives a communication request signal sent by the user A from the first dialer 10 by the user and starts searching for the corresponding account numbers of the user A and the user B. After the search ends, the communication request signal is sent to a server 40 with the found corresponding account number. Finally, the server 40 sends the communication connection signal to the first telecommunication device 20 and the second telecommunication device 30 with the corresponding account number according to the communication request signal to let the user A conduct a voice or video conference with the user B as shown in FIG. 3. Refer to FIG. 4 for a clearer illustration. All of the first telecommunication devices 20 and second telecommunication devices 30 have their respective account numbers respectively, and all account numbers can be saved into the cloud interface 50. In FIG. 4, an account number set in the first telecommunication device 20 owned by the user A is created by one of the servers 40, and another set account number corresponds to another server 40. Similarly, an account number set in the second telecommunication device 30 owned by the user B is created by one of the servers 40, and another set account number corresponds to another server 40, wherein one of the account numbers set by the second telecommunication device 30 of the user B corresponds to one of the first telecommunication devices 20 of the user A, and the cloud interface 50 search for this relation, and then the corresponding server 40 connect this matched account number of the first telecommunication device 20 and the second telecommunication device 30 to establish a communication connection channel and let the users A and B talk with each other.

In summation of the description above, the telephone communication method of the present invention allow users to dial a number and talk with others through different devices and break through the conventional telephone communication mode to create a novel communication method. In addition, the telephone communication method let a user talk with an opposite part based on the same group or a certain communication range to obtain better communication service and quality.

What is claimed is:

1. A telephone communication method, comprising:
sending a communication request signal via a first dialer;
receiving the communication request signal by a server for sending a communication connection signal to a first telecommunication device and a second telecommunication device with a predetermined account number corresponding to the server according to the communication request signal to establish a communication connection channel between the first telecommunication device and the second telecommunication device; and
using the first telecommunication device and the second telecommunication device to conduct a voice communication or a video communication.

2. The telephone communication method of claim 1, wherein the server is a Session Initiation Protocol (SIP) server and the predetermined account number is a SIP account number created by the server.

3. The telephone communication method of claim 2, wherein the first dialer and the first telecommunication device are provided for the same user to dial a number or to talk, and the second telecommunication device is provided for another user to talk.

4. The telephone communication method of claim 3, further comprising the steps of:
designating the first telecommunication device as a talking tool and sending the communication request signal by the first dialer; and
sending the communication connection signal to the first telecommunication device and the second telecommunication device corresponding to the predetermined account number of the first telecommunication device according to the communication request signal via the server to establish the communication connection channel between the first telecommunication device and the second telecommunication device.

5. The telephone communication method of claim 4, further comprising the steps of:
using the first dialer to provide the user to select another user as a talking object, and sending the communication request signal by the first dialer;
receiving the communication request signal by a cloud interface, and using the predetermined account number of the designated first telecommunication device as a search element to search the predetermined account number registered by the another user corresponding to the predetermined account number of the first telecommunication device;
sending the communication request signal to the server corresponding to the predetermined account number by the cloud interface; and
sending the communication connection signal to the first telecommunication device and the second telecommunication device of the predetermined account number registered by the another user according to the communication request signal by the server.

6. The telephone communication method of claim 5, wherein the first telecommunication device, the second telecommunication device and the server come with a plural quantity each, and each of the first telecommunication devices and each of the second telecommunication devices corresponding to one of the predetermined account numbers are registered and saved in the cloud interface, and each of the predetermined account numbers corresponds to one of the servers, and the telephone communication method comprises the steps of:
designating at least one of the first telecommunication devices as the talking tool and sending the communication request signal by the first dialer;
using the predetermined account number of the first telecommunication device designated as the talking tool via the cloud interface as a search element to search the second telecommunication device matched with the predetermined account number of one of the first telecommunication devices; and
sending the communication request signal to one of the servers corresponding to the predetermined account number according to the matched predetermined account number via the cloud interface, and then sending the communication connection signal by the corresponding server to the first telecommunication device and second telecommunication device are matched.

7. The telephone communication method of claim 1, applicable for being executed under a Voice over Internet Protocol (VOIP).

8. The telephone communication method of claim 1, further comprising the steps of:
sending the communication connection signal to the first telecommunication device, the second telecommunication device and other telecommunication devices with the predetermined account number corresponding to the server according to the communication request signal by the server; and establishing the communication connection channel between the first telecommunication device, the second telecommunication device and the other telecommunication devices by the server, and conducting a multi-party voice or video conference by the first telecommunication device, the second telecommunication device and the other telecommunication devices.
